(19) United States
(12) Patent Application Publication
(10) Pub. No.: US 2007/0114137 A1
(43) Pub. Date: May 24, 2007

(54) Residual chlorine measuring method and residual chlorine measuring device

(76) Inventors: Satoshi Nomura, Kyoto (JP); Yasuaki Einaga, Tokyo (JP); Koichi Matsumoto, Kyoto (JP); Michio Murata, Kanagawa (JP); Mamoru Shibata, Tokyo (JP)

Correspondence Address: SNELL & WILMER LLP (OC), 600 ANTON BOULEVARD, SUITE 1400, COSTA MESA, CA, 92626, US

(21) Appl. No.: 11/602,648

(22) Filed: Nov. 21, 2006

(30) Foreign Application Priority Data
Nov. 22, 2005 (JP) P2005-337769

(51) Int. Cl. G01N 27/26

(52) U.S. Cl. 205/778.5; 204/400

(57) ABSTRACT

A residual chlorine measuring method includes the steps of bringing a counter electrode, a working electrode and a reference electrode into contact with a sample solution containing a residual chlorine. Applying a voltage between the counter electrode and the working electrode and measuring a current value to calculate a concentration of the residual chlorine. The working electrode is an electrically conductive diamond electrode to which an element selected from a group of boron, nitrogen and phosphorus is doped into a diamond coating. The reference electrode is a silver/silver chloride electrode. A current value, when setting the potential of the electrically conductive diamond electrode to the silver/silver chloride electrode, is in the range of +0.5 V to +1.5 V for measurements.

### BACKGROUND OF THE INVENTION

1. Field of the Invention

The present invention relates to a method and device for measuring a residual chlorine concentration using an electrochemical method.

2. Description of Related Art

There has been a calorimetric assay method using a reagent such as a DPD method and an orthotolidine method and a polarographic method using an electrode as a method for measuring residual chlorine in a sample solution.

In the DPD method, a measurer compares any pinkish red color produced, by reacting the residual chlorine with diethyl-p-phenylenediamine (DPD), with a color chart to determine the concentration of the residual chlorine. In the orthotolidine method, the measurer compares yellow color produced by reacting the residual chlorine with a chloride solution of orthotolidine with the color chart to determine the concentration of the residual chlorine.

However, since these methods are based on the visual judgment of the measurer, there is a problem in that individual difference arises is in the measured value. There is also a problem in that waste liquid treatment is required after the measurement. Furthermore, there is also a problem in that the cost for the preparation of the reagent is high.

On the other hand, the polarographic method using the electrode determines the concentration of the residual chlorine by a current between a counter electrode and a working electrode. Since this method does not require the reagent, the waste liquid treatment is not required, and furthermore, the residual chlorine is easily measured.

However, since the conventional polarographic method uses a platinum electrode for the working electrode as shown in Japanese Examined Patent Publication No. 1980-17939, there is a problem in that an oxidation current peak of the residual chlorine appears only in the vicinity of the limit of a potential window, and overlaps the potential window, thereby disturbing the exact measurement.

Thus, there remains a desire to provide an economical and improved method and device for measuring a chlorine concentration.

### SUMMARY OF THE INVENTION

The present invention has been developed to eliminate the conventional problems described above. It is a desired object of the present invention to provide an objective measured result without using a harmful reagent and furthermore to correctly and easily measure the residual chlorine without being influenced by a potential window.

That is, a residual chlorine measuring method according to the present invention, includes the steps of putting a counter electrode, a working electrode and a reference electrode into contact with a sample solution containing residual chlorine, which is an object to be measured, applying a voltage between the counter electrode and the working electrode, and measuring a current value under the voltage to calculate a concentration of the residual chlorine, wherein the working electrode is an electrically conductive diamond electrode to which a group 13 element or a group 15 element is doped. The reference electrode is a silver/silver chloride electrode and a current value is measured when a potential of the electrically conductive diamond electrode is set between +0.5 V to +1.5 V when compared to a potential of the silver/silver chloride electrode.

Herein, setting the potential of the electrically conductive diamond electrode to the silver/silver chloride electrode in the range of +0.5 V to +1.5 V is based on a peak of a current produced by an oxidation reaction of the residual chlorine is generated between +0.5 V and +1.5 V and the oxidation-reduction reaction of the residual chlorine is generally not less than +0.5 V.

In the present invention, the term residual chlorine means all available chlorines which remain in the water, and includes two kinds, that is, free residual chlorine and bonding residual chlorine. The free residual chlorine is chlorine (Cl2), hypochlorous acid (HClO) and hypochlorous acid ion (ClO⁻). The bonding residual chlorine is monochloramine (NH2Cl), dichloramine (NHCl2) and trichloramine (NCl3).

The residual chlorine measuring method can provide an objective measured result without using a harmful reagent. Also, since the electrically conductive diamond electrode to which the group 13 element or the group 15 element is doped has an advantageous character in which a potential window for an oxidation potential and an reduction potential is wide and a background current (a residual current) is lower than those of the other electrode materials, the concentration of the residual chlorine can be highly sensitively, highly precisely and easily measured. Furthermore, the potential of the electrically conductive diamond electrode to the silver/silver chloride electrode is changed only within the range of +0.5 V to +1.5V where the peak of the current due to the oxidation reaction of the residual chlorine is generated and it is not necessary to measure a potential less than +0.5 V. Thereby, it is possible to measure the concentration of the residual chlorine in a short period of time.

The group 13 element or the group 15 element is preferably at least one kind of an element selected from a group consisting of boron, nitrogen and phosphorus, and particularly preferably is a boron-doped diamond electrode into which the boron is mixed.

Although examples of the surface states of the above electrically conductive diamond electrode to which the boron is doped include a hydrogen-terminated surface state and an oxygen-terminated surface state, the hydrogen-terminated surface state is more preferable. The reason for this is the following.

That is, in the electrically conductive diamond electrode oxygen-terminated, the oxidation potential corresponding to the detected peak current is at a higher potential side, and the peak current comes near the potential window, and thereby the sensitivity may be reduced. However, in the electrically conductive diamond electrode hydrogen-terminated, the oxidation potential corresponding to the detected peak current is at a lower potential side as compared with a case of using the electrically conductive diamond electrode oxygen-terminated and the peak current is separately detected from the potential window, thereby further enhancing the sensitivity.

Also, as a specific method for oxygen-terminating, it is desirable to anodize the electrically conductive diamond electrode or subject the electrically conductive diamond electrode to an oxygen plasma treatment to oxygen-terminate the electrically conductive diamond electrode. As a specific method for hydrogen-terminating the electrically conductive diamond electrode, it is desirable to anneal (heat) the electrically conductive diamond electrode under a hydrogen atmosphere or cathodically reduce the electrically conductive diamond electrode to hydrogen-terminate the electrically conductive diamond electrode.

Also, the residual chlorine measuring method according to the present invention can be carried out by, for example, a measuring device having the following constitution. That is, a residual chlorine measuring device for measuring a residual chlorine concentration in a sample solution, includes a working electrode, a counter electrode, a reference electrode, a voltage applying part for applying a voltage to the working electrode and the counter electrode, a current measuring part for measuring a current value in the applied voltage, and an information processor for calculating a residual chlorine concentration based on a current measuring signal from the current measuring part. The working electrode is an electrically conductive diamond electrode to which a group 13 element or a group 15 element is doped. The reference electrode is a silver/silver chloride electrode and the information processor controls the potential of the electrically conductive diamond electrode to the silver/silver chloride electrode to a range of +0.5 V to +1.5 V.

Thus, the present invention can provide an objective measured result and remove the subjective interpretation of color shades without using any harmful reagent.

Also, since the electrically conductive diamond electrode to which the group 13 element or the group 15 element is doped has an advantageous character in which potential windows of an oxidation potential and an reduction potential are wide and a background current (a residual current) is lower than those of the other electrode materials, the concentration of the residual chlorine can be determined with high sensitively, highly precisely and further easily measured.

Furthermore, the potential of the electrically conductive diamond electrode to the silver/silver chloride electrode is changed only within the range of +0.5 V to +1.5V where a peak of any current due to the oxidation reaction of the residual chlorine is generated and it is not necessary to measure a potential below +0.5 V. Thereby, it is possible to measure the concentration of the residual chlorine in a short time period.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings.

FIG. 1 is a schematic constitution diagram of a residual chlorine measuring device according to a first embodiment of the present invention;

FIG. 2 is voltammogram for each of the concentrations of residual chlorines when linearly sweeping a potential of a working electrode between +0.5 V and +1.5 V in the embodiment;

FIG. 3 shows a calibration curve produced based on the current-voltage curve shown in FIG. 2;

FIG. 4 is a schematic constitution diagram of a residual chlorine measuring device according to a second embodiment of the present invention;

FIG. 5 shows a current value of each of the concentrations of residual chlorines when a potential of a working electrode is +1.1 V in the embodiment; and

FIG. 6 shows a calibration curve produced based on the measured results shown in FIG. 5.

### DETAILED DESCRIPTION OF THE PREFERRED EMBODIMENTS

Reference will now be made in detail to the preferred embodiments of the invention which set forth the best modes contemplated to carry out the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

Hereinafter, a first embodiment of a residual chlorine measuring device according to the present invention will be described referring to the drawings.

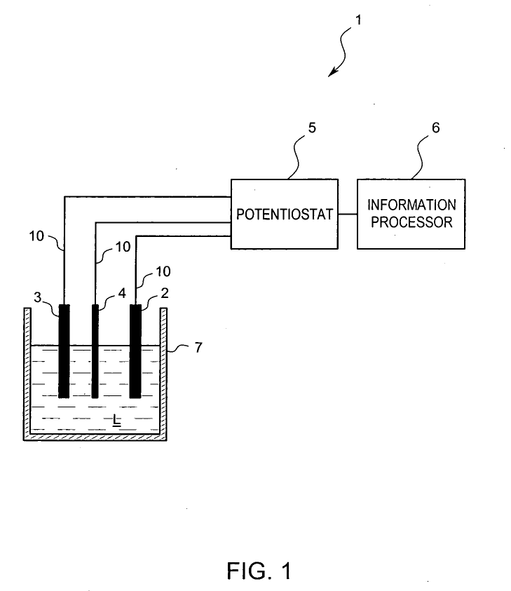

A residual chlorine measuring device 1 according to the present embodiment is a batch-type electrochemistry measuring device which analyzes a sample solution L by dissolving an electrolyte in the sample solution L to produce an electrolyte solution and then, by applying a voltage to the solution, performs voltammetry measurement for analyzing the solution L due to a triple electrode system. As shown in FIG. 1, the basic constitution includes a working electrode 2, a reference electrode 3, a counter electrode 4, a potentiostat 5 for controlling the voltages of the working electrode 2, the reference electrode 3 and the counter electrode 4, and an information processor 6, such as a programmed microprocessor or controller, for calculating, for example, the concentration of residual chlorine contained in the sample solution L based on a current and voltage obtained by the potentiostat 5.

The sample solution L contains the residual chlorine which is the object to be measured, and the embodiment uses hypochlorite. Also, sodium perchlorate (NaClO4) of 0.1 M is used as the electrolyte.

The working electrode 2 applies a voltage to the sample solution, and is a boron-doped diamond electrode to which conductivity is imparted by adding boron with high density. Also, the working electrode 2 is fixed by a holding member which is not shown so as to be immersed in the sample solution L accommodated in a measuring cell 7. The potential to the reference electrode 3 is swept between +0.5 V and +1.5 V by the information processor 6 to be described later. The boron-doped diamond electrode 1 to which boron is doped at high concentration has an advantageous character in that a potential window is wide (an oxidation potential and a reduction potential are wide) and a background current is lower than those of the other electrode materials. Also, the boron-doped diamond, electrode 1 is excellent in chemical resistance, durability, electrical conductivity and corrosion resistance.

The boron-doped diamond electrode used in the present invention is produced by forming a diamond film on an upper surface of a silicon substrate by, for example, using a microwave plasma CVD method. Now, boron is doped as impurities in order to make the diamond film conductive. A specific manufacturing method is as follows.

A silicon substrate (Si) is used as a substrate. A mixed solution of acetone (72 ml) and methanol (8 ml) is used as a carbon source. Boron oxide (B₂O₃) (1.09 g) is dissolved in the mixed solution. After this carbon source is bubbled by hydrogen gas, the carbon source is introduced into a chamber where a film is formed at a substrate temperature of about 800° C.

Although the addition amount of the boron to be mixed is suitably determined in the range capable of imparting conductivity to the diamond electrode 1, for example, the addition amount imparts the conductivity of about 1×10⁻² to about 10⁻⁶ Ωcm to the diamond electrode 1.

The surface of the electrically conductive diamond electrode 1 thus formed is almost hydrogen-terminated in the “as grown” state (a surface treatment or the like is not then applied with a crystal grown on a substrate).

Then, the electrically conductive diamond electrode 1 in the “as grown” state is cathodically reduced by applying the voltage of 1.8 V to the electrically conductive diamond electrode 1 and by immersing in a sulfuric acid (H₂SO₄) of 0.1 M for 30 minutes to hydrogen-terminate the entire surface of the electrically conductive diamond electrode 1.

The reference electrode 3 is used as the standard of the potential of the working electrode 2, and the present embodiment uses a silver/silver chloride electrode (Ag/AgCl electrode). The reference electrode 3 is fixed by a holding member which is not shown so as to be immersed in the sample solution L accommodated in the measuring cell 7.

The counter electrode 4 makes a current flow in the working electrode 2 without any trouble when setting the working electrode 2 to a potential, and is connected to the working electrode 2 in series. The present embodiment uses a platinum (Pt) electrode. The counter electrode 4 is also fixed by the holding member which is not shown so as to be immersed in the sample solution L accommodated in the measuring cell 7 as in the case of the reference electrode 3.

The potentiostat 5 functions as a voltage applying part for applying the voltage to the working electrode 2, the reference electrode 3 and the counter electrode 4, and a current measuring part for measuring a current value in the applied voltage. The potentiostat 5 is controlled by the information processor 6 to be described later. The potentiostat 5 receives voltage signals and current signals from the working electrode 2, the reference electrode 3 and the counter electrode 4, and controls these electrodes 2, 3, 4. The potentiostat 5 always adjusts a voltage applied between the working electrode 2 and the counter electrode 4, and controls a voltage of the working electrode 2 to the reference electrode 3. Specifically, the potentiostat 5 scans at a rate of, for example, 100 mV/s while setting the potential of the working electrode 2 to the reference electrode 3 to +0.5 V to +1.5 V and detects a current value accompanying an oxidation reaction under the voltage.

The information processor 6 controls the potentiostat 5, determines a current-voltage curve based on voltage signals and current signals from the potentiostat 5, and calculates the concentration of the residual chlorine contained in the sample solution L based on the current-voltage curve. Furthermore, the information processor 6 controls the potentiostat 5 so as to change the potential of the working electrode 2 to the reference electrode 3 at a rate of, for example, 100 mV/s while setting the potential to +0.5 V to +1.5 V when measuring the concentration of the residual chlorine. Specifically, the information processor 6 has a CPU, an internal memory, an external storage such as a HDD, a communication interface such as a modem, a display, a mouse, and an input means such as a keyboard. The information processor 6 analyzes electric signals according to programs set in a predetermined region of the internal memory and the external storage or the like to detect the residual chlorine and calculates the concentration thereof. The information processor 6 may be a generalized computer, or may be dedicated to this measurement apparatus.

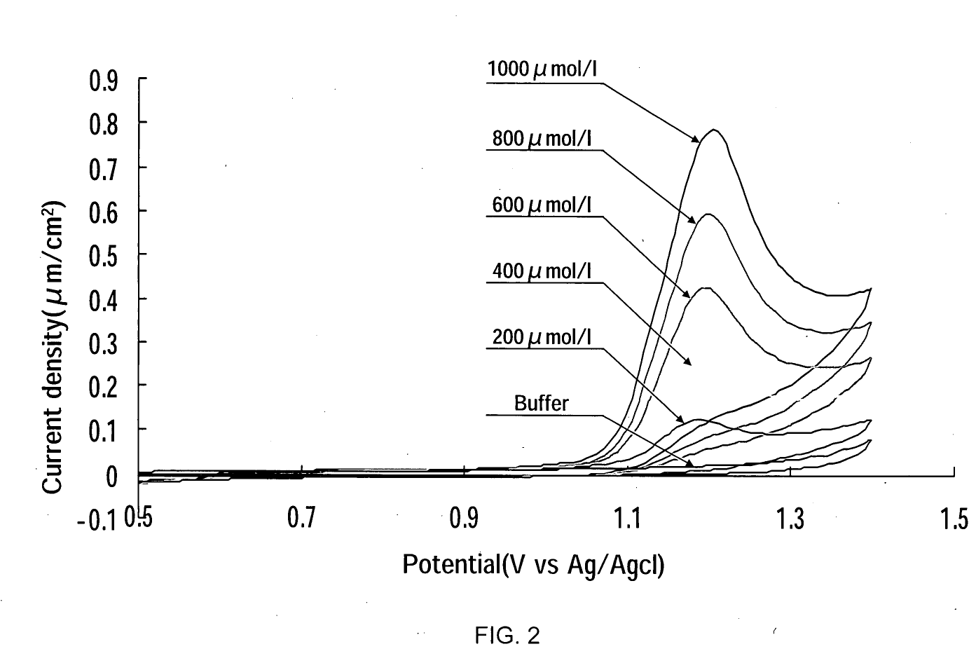

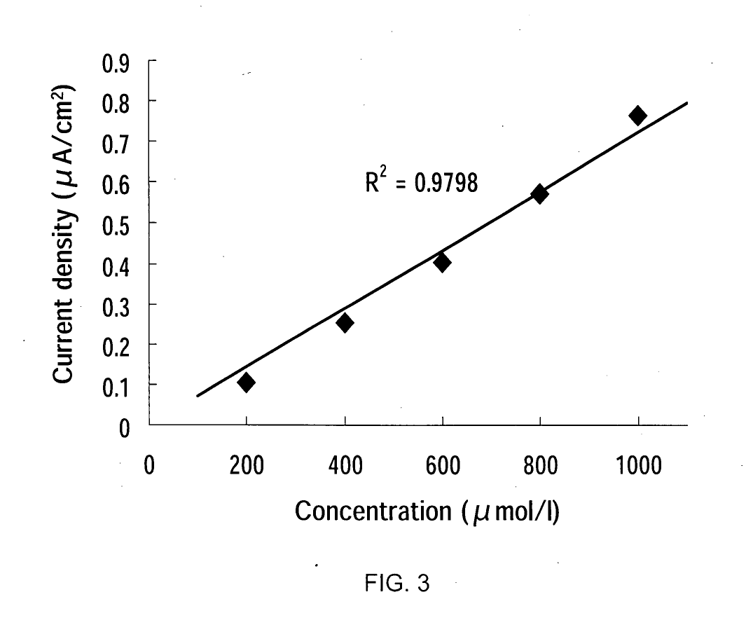

Next, FIGS. 2 and 3 show results obtained by measuring the residual chlorine contained in the sample solution L using the residual chlorine measuring device 1 according to the present embodiment.

FIG. 2 shows a current-voltage curve (voltammogram) obtained by measuring current values when linearly sweeping (100 mV/s) the potential of the working electrode 2 to the reference electrode 3 by the potentiostat 5 using the sample solutions L obtained by adjusting the concentration of the residual chlorine contained in the sample solutions L to 200, 400, 600, 800, 1000 μM.

FIG. 3 shows a calibration curve of concentrations and current values in peak potentials in the vicinity of +1.2 V based on the results obtained in FIG. 2. As shown in FIG. 3, the calibration curve in which the concentration of the residual chlorine closely correlates with the current value is shown. Therefore, even a small amount (low concentration) of the residual chlorine can be correctly measured.

The residual chlorine measuring device 1 according to the present embodiment thus constituted can obtain an objective measured result without using a harmful reagent. Also, since the electrically conductive diamond electrode 2 to which the boron is doped has an advantageous character in which the potential window (the oxidation potential and the reduction potential are wide) is wide and the background current (a residual current) is lower than those of the other electrode materials, the concentration of the residual chlorine can be highly sensitively, highly precisely and easily measured. Furthermore, the potential of the electrically conductive diamond electrode 2 to the silver/silver chloride electrode 3 is changed only within the range of +0.5 V to +1.5V wherein the peak of the current due to the oxidation reaction of the residual chlorine is generated and it is not necessary to measure a potential below +0.5 V. Thereby, it is possible to measure the concentration of the residual chlorine for a short time.

Next, a second embodiment of the residual chlorine measuring device 1 according to the present invention will be described referring to the drawings. Elements corresponding to the first embodiment are designated by the same numerals.

The residual chlorine measuring device 1 according to the present embodiment performs a so-called flow injection analysis (FIA).

The flow injection analysis (FIA) produces continued flow control of a sample by using a metering pump or the like, performs various reactions, a separation and a sample pouring or the like in this flow, and analyzes components contained in a solution using a detector provided with a flow cell provided at the end.

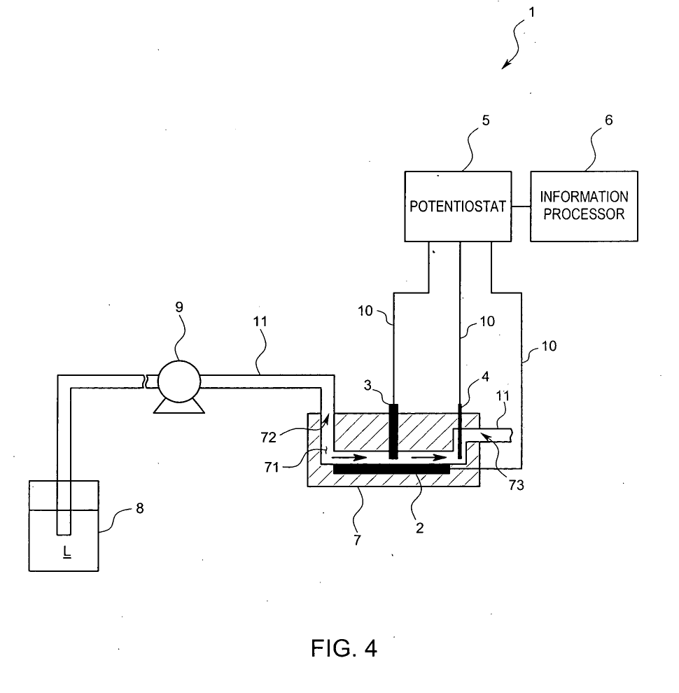

As shown in FIG. 4, the specific constitution of the device contains a flow cell 7 provided on a flow route of the sample solution L, the working electrode 2, the reference electrode 3 and the counter electrode 4 are incorporated in the flow cell 7. The potentiostat 5 controls the voltages of the working electrode 2, the reference electrode 3 and the counter electrode 4. An information processor 6 calculates the concentration or the like of the residual chlorine in the sample solution L based on the current and the voltage obtained by the potentiostat 5.

The sample solution L contains the residual chlorine which is the object to be measured, and the present embodiment uses hypochlorite. Also, sodium perchlorate (NaClO₄) of 0.01 M is used as the electrolyte.

The flow route is composed by a flow pipe 11 and the flow cell 7. The flow pipe 11 connects a solution tank 8 to an inflow port 72 of the flow cell 7, and connects an outflow port 73 of the flow cell 7 to a waste fluid tank (not shown). Also, a pump 9 is provided on a feed pipe 11 provided at an upstream side of the flow cell 7.

The flow cell 7 is constituted so that the electrically conductive diamond electrode 2, the reference electrode 3 and the counter electrode 4 are exposed in a flow passage 71 in which the sample solution L flows and can be brought into contact with the sample solution L. The diamond thin film of the electrically conductive diamond electrode 2 is exposed in the flow passage 71 and is brought into contact with the sample solution L. The sample solution L enters from the inflow port 72 of the flow passage 71, flows as shown by the arrow in FIG. 4, and reaches to the outflow port 73. An electrochemical reaction is generated in the sample solution L by applying a voltage between the working electrode 2 and the counter electrode 4.

The pump 9 is provided on the flow pipe 11 between the solution tank 8 and the flow cell 7, and can supply the sample solution L to the flow cell 7 at a fixed speed. For example, the pump 9 is a pump or the like for liquid chromatography.

Next, the operation of the residual chlorine measuring device 1 thus constituted will be described.

First, the sample solution L containing the residual chlorine which is the object to be measured is supplied to the flow cell 7 through the flow pipe 11 from the solution tank 8 by the pump 9. The electrochemical reaction is generated by applying a voltage between the working electrode 2 and the counter electrode 4 while the working electrode 2, reference electrode 3 and counter electrode 4 incorporated in the flow cell 7 are brought into contact with the sample solution L. A current value (electric signals) produced by the electrochemical reaction is transmitted to the potentiostat 5, and the signals in each of the electrodes are controlled and detected. The signals detected by the potentiostat 5 are analyzed by the information processor 6, thereby detecting the residual chlorine and measuring the concentration thereof. The measured sample solution L is discharged out of the flow cell 7, and is accommodated in the waste fluid tank through the flow pipe 11.

Herein, the voltage applied between the working electrode 2 and the counter electrode 4 in the present embodiment is set to a voltage capable of producing the maximum current value or within the vicinity thereof, in view of measurement efficiency and accuracy. Specifically, since the voltage which produces the maximum current value of the residual chlorine is about 1.2 V, the voltage applied between the working electrode 2 and the counter electrode 4 is set to about 1.1 V. Herein, the voltage which imparts the maximum current value imparts the maximum current value by, for example, cyclic voltammetry (CV). The voltage which imparts the maximum current value can be also determined by a rotating electrode method or a micro electrode method. The rotating electrode method or the micro electrode method is advantageous since the methods can further reduce or eliminate any possibility of an error of measurement due to measurement conditions or the like.

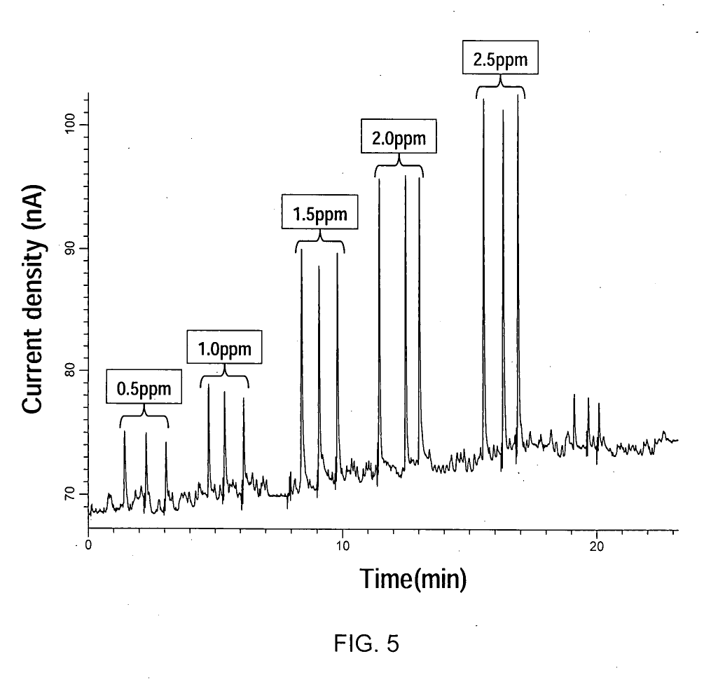

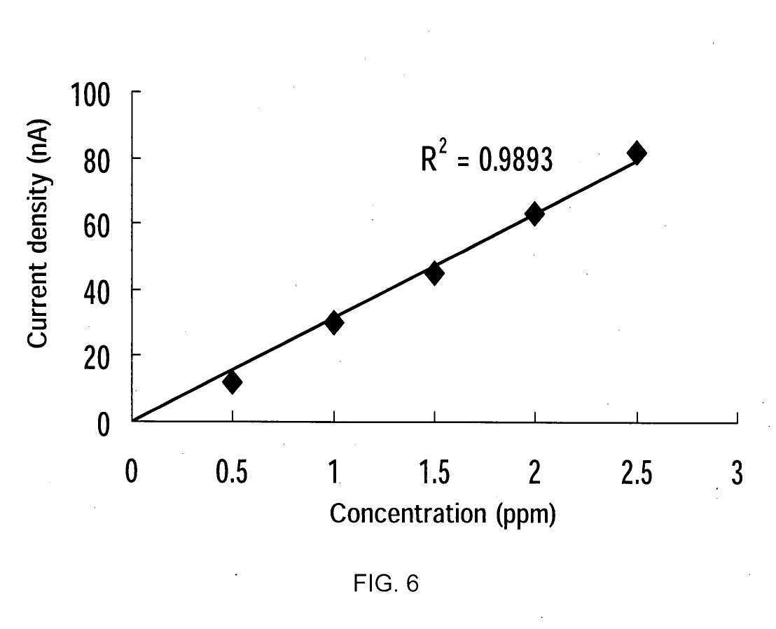

Next, FIGS. 5 and 6 show results obtained by measuring the residual chlorine contained in the sample solution using the residual chlorine measuring device 1 according to the second embodiment.

FIG. 5 shows the time change of currents obtained by using the sample solutions L obtained by adjusting the concentration of the residual chlorine contained in the sample solution L to 0.5, 1.0, 1.5, 2.0, 2.5 ppm and measuring current values of the sample solutions L when setting the potential of the working electrode 2 to the reference electrode 3 to +1.1 V by the potentiostat 5.

FIG. 6 shows a calibration curve of concentration and current values when the applied voltage is +1.1 V based on the results obtained in FIG. 5. As shown in FIG. 6, the calibration curve in which the residual chlorine correlates a maximum current value is almost linear. Therefore, even a small amount (low concentration) of the residual chlorine can be correctly measured.

The residual chlorine measuring device according to the second embodiment thus constituted can measure the concentration of the residual chlorine in a lower concentration region than the first embodiment in addition to the effect of the first embodiment.

The present invention is not limited to these embodiments.

For example, although the residual chlorine measuring devices of the preferred embodiments use a three-electrode method equipped with the counter electrode, the working electrode and the reference electrode, the residual chlorine measuring device may be based on a two-electrode method provided with only the working electrode and the counter electrode. Since the three-electrode method can control the absolute value of the voltage applied between the working electrode and the counter electrode, the three-electrode method can measure highly precisely and highly sensitively. However, since the two-electrode method uses only two electrodes, that is, the working electrode and the counter electrode, the constitution of the flow cell can be simplified and miniaturized. In addition, the measuring cell can be also chipped and disposed, and a simpler measurement can be performed.

Also, in the embodiments, the electrically conductive diamond electrode may take the form of a micro electrode. Herein, the diamond electrode of the micro electrode form is obtained by sharply cutting the end of a thin wire made of for example, Pt or the like, making the end sharper by electrolytic polishing and then forming a thin film of a conductive diamond on the end surface.

Furthermore, although the counter electrode is the platinum (Pt) electrode in the embodiments, for example, carbon, stainless steel, gold, diamond and SnO₂ or the like can be also used.

In addition, although the reference electrode is the silver/silver chloride electrode (Ag/AgCl electrode) in the embodiments, for example, a standard hydrogen electrode, a mercury/mercury chloride electrode, a hydrogen palladium electrode or the like can be also used.

In addition, although the surface of the electrically conductive diamond electrode is hydrogen-terminated in the embodiments, an electrically conductive diamond electrode oxygen-terminated may be used.

The method for hydrogen-terminating the surface of the electrically conductive diamond electrode is not limited to the cathodic reduction treatment, and the other various methods such as a method for heating (annealing) at 700° C. or more under a hydrogen atmosphere can be used.

Also, as a method for oxygen-terminating the surface of the electrically conductive diamond electrode, the electrically conductive diamond electrode can be anodized by applying the voltage of 3.0 V to the electrically conductive diamond electrode of the “as grown” state described above and by immersing the electrically conductive diamond electrode in a sulfuric acid (H₂SO₄) of 0.1M for 30 minutes. Also, in addition, the other various methods such as a treatment using oxygen plasma can be used.

Furthermore, in addition, although sodium perchlorate is used as an electrolyte which has a buffer action in each of the embodiments, the electrolyte is not limited thereto, and, for example, a phosphate buffer solution (PBS) or the like used as a buffer solution can be also used.

Furthermore, in addition, although the electrically conductive diamond electrode to which the boron is doped is used in the embodiments, an electrically conductive diamond electrode to which a group 13 element or a group 15 element such as nitrogen and phosphorus is doped may be used.

In addition, a part or all of each of the embodiments or modification embodiments described above may be suitably combined. The present invention is not limited to each of the embodiments, and needless to say, various changes can be made within the scope of the present invention without departing the spirit.

Those skilled in the art will appreciate that various adaptations and modifications of the just-described preferred embodiment can be configured without departing from the scope and spirit of the invention. Therefore, it is to be understood that, within the scope of the amended claims, the invention may be practiced other than as specifically described herein.

What is claimed is:

1. A residual chlorine measuring method comprising the steps of:
providing a counter electrode, a working electrode and a reference electrode in contact with a sample solution containing a residual chlorine sample which is an object to be measured;
applying a voltage between the counter electrode and the working electrode; and
measuring a current value under the voltage to calculate a concentration of the residual chlorine,
wherein the working electrode is an electrically conductive diamond electrode to which a group 13 element or a group 15 element is doped,
the reference electrode is a silver/silver chloride electrode, and
a current value is measured when a potential of the electrically conductive diamond electrode is set in a range between +0.5 V to +1.5 V when compared to a potential of the silver/silver chloride electrode.

2. The residual chlorine measuring method according to claim 1, wherein the working electrode is an electrically conductive diamond electrode in which at least one element selected from a group consisting of boron, nitrogen and phosphorus is doped.

3. The residual chlorine measuring method according to claim 1, wherein a surface of the electrically conductive diamond electrode is hydrogen-terminated.

4. The residual chlorine measuring method according to claim 1, wherein a surface of the electrically conductive diamond electrode is oxygen-terminated.

5. A residual chlorine measuring device for measuring a residual chlorine concentration in a sample solution, comprising:
a working electrode;
a counter electrode;
a reference electrode;
a voltage applying part for applying a voltage to the working electrode and the counter electrode;
a current measuring part for measuring a current value in the applied voltage; and
an information processor for calculating a residual chlorine concentration based on a current measuring signal from the current measuring part,
wherein the working electrode is an electrically conductive diamond electrode to which a group 13 element or a group 15 element is doped,
the reference electrode is a silver/silver chloride electrode, and
the information processor controls the potential of the electrically conductive diamond electrode to the silver/silver chloride electrode in an approximate range of +0.5 V to +1.5 V.

6. The residual chlorine measuring device according to claim 5, wherein the working electrode is an electrically conductive diamond electrode in which at least one element selected from a group consisting of boron, nitrogen and phosphorus is doped.

7. The residual chlorine measuring device according to claim 5, wherein a surface of the electrically conductive diamond electrode is hydrogen-terminated.

8. The residual chlorine measuring device according to claim 5, wherein a surface of the electrically conductive diamond electrode is oxygen-terminated.

9. A residual chlorine measuring system for measuring a residual chlorine concentration in a sample solution, comprising:
a sample cell including a working electrode, a counter electrode, and a reference electrode;
a source of sample solution;
a pump unit for providing a constant flow of sample solution to the sample cell;
a voltage applying unit for applying a voltage to the working electrode and the counter electrode;
a current measuring unit for measuring a current value in the applied voltage; and
an information processor for calculating a residual chlorine concentration based on a current measuring signal from the current measuring part,
wherein the working electrode is an electrically conductive diamond electrode doped with boron to provide a conductivity of approximately 1×10⁻² to 10⁻⁶ Ωcam,
the reference electrode is a silver/silver chloride electrode and
the information processor controls the potential of the electrically conductive diamond electrode to the silver/silver chloride electrode in an approximate range of +0.5 V to +1.5 V.

10. The residual chlorine measuring device according to claim 9, wherein the working electrode is an electrically conductive diamond electrode in which at least one element selected from a group consisting of boron, nitrogen and phosphorus is doped.

11. The residual chlorine measuring device according to claim 9, wherein a surface of the electrically conductive diamond electrode is hydrogen-terminated.
